(19) United States
(12) Patent Application Publication
(10) Pub. No.: US 2026/0001178 A1
(43) Pub. Date: Jan. 1, 2026

(54) TROLLEY ASSEMBLY FOR DRILLING MAST

(71) Applicant: Caterpillar Inc., Peoria, IL (US)

(72) Inventors: David Antony, Chennai (IN); David Richard Wisley, Prosper, TX (US); Arunkumar Palaniappan, Chennai (IN); Karthik Thiagarajan, Madurai (IN); Garrett Schick, Tom Bean, TX (US); Bibish Biju Antony, Alappuzha (IN); Kyle D. Heavrin, Van Alstyne, TX (US); Kyle Charles Kingdon, Sherman, TX (US)

(73) Assignee: Caterpillar Inc., Peoria, IL (US)

(21) Appl. No.: 18/754,387

(22) Filed: Jun. 26, 2024

(51) Int. Cl. B23P 21/00; B23P 15/32

(52) U.S. Cl. CPC B23P 21/004; B23P 15/32

(57) ABSTRACT

A trolley assembly includes a first trolley. The first trolley includes a first assembly including a first positioning system. The first positioning system includes a first housing and a first rotatable element. The first trolley also includes a second assembly separate from the first assembly and removably coupled with the first assembly via a drilling mast. The second assembly includes a second positioning system. The second positioning system includes a second housing and a second rotatable element. The first trolley further includes an actuation device disposed in at least one of the first positioning system and the second positioning system. Upon operation of the actuation device, the actuation device rotates the drilling mast relative to each of the first housing of the first positioning system and the second housing of the second positioning system to dispose the drilling mast at a plurality of work positions.

### TECHNICAL FIELD

The present disclosure relates to a trolley assembly for a drilling mast and a method of using the trolley assembly for the drilling mast.

### BACKGROUND

A work machine includes a drilling mast that supports a drill motor and a drill head of the work machine. The work machine may include, for example, a drilling machine or a drill rig. The drilling mast is a long structural member that is typically transported between different workstations along an assembly line to perform one or more assembly/manufacturing operations thereon. The workstations may include, for example, a shot blast bay, a paint bay, a fabrication bay, an assembly bay, a weld inspection bay, and the like. However, transporting the drilling mast between various workstations is a tedious and a time-consuming process.

Generally, trolleys are used for transporting the drilling mast between different workstations along the assembly line. A current design of the trolley requires unloading and loading of the drilling mast at each workstation. In some cases, overhead cranes are used for loading and unloading the drilling mast from the trolley. However, overhead cranes may not be available at some workstations, which may increase a complexity of unloading and loading the drilling mast and may also increase waiting time along the assembly line. Further, in some cases, an operator may have to crawl under the trolley at some workstations to access a complete area of the drilling mast, which may not be ergonomic and may cause operator fatigue. Overall, the trolleys that are currently being employed may increase a throughput time of the assembly line and may reduce a productivity of the assembly line.

DE102021003283A1 describes a lifting and turning device for loads, in particular for receiving a commercial vehicle frame, comprising a turning unit for the load, which is formed on two holding arms of a base unit. In a lifting and turning device for large-dimensioned loads, the turning process of which is kept as short as possible to optimize assembly, a lifting column extending vertically upwards from the trolley is arranged on two base units designed as trolleys, to which the vertically displaceable, rotatably mounted turning unit is attached as a support arm of the load.

### SUMMARY OF THE DISCLOSURE

In an aspect of the present disclosure, a trolley assembly for a drilling mast is provided. The trolley assembly includes a first trolley. The first trolley includes a first assembly disposed at a first side of the first trolley. The first assembly includes a first frame. The first assembly also includes a plurality of first ground engaging members coupled to the first frame. The first assembly further includes a first positioning system disposed on the first frame. The first positioning system includes a first housing and a first rotatable element that is rotatable relative to the first housing. The first rotatable element is adapted to be removably coupled with a first end of the drilling mast. The first trolley also includes a second assembly disposed at a second side of the first trolley. The second assembly is separate from the first assembly. The second assembly is adapted to be removably coupled with the first assembly via the drilling mast. The second assembly includes a second frame. The second assembly also includes a plurality of second ground engaging members coupled to the second frame. The second assembly further includes a second positioning system disposed on the second frame. The second positioning system includes a second housing and a second rotatable element that is rotatable relative to the second housing. The second rotatable element is adapted to be removably coupled with a second end of the drilling mast. The second end of the drilling mast being spaced apart from the first end of the drilling mast. The first trolley further includes an actuation device disposed in at least one of the first positioning system and the second positioning system. Upon operation of the actuation device, the actuation device is adapted to rotate the drilling mast relative to each of the first housing of the first positioning system and the second housing of the second positioning system to dispose the drilling mast at a plurality of work positions.

In another aspect of the present disclosure, a method of using a trolley assembly for a drilling mast is provided. The method includes disposing a first assembly of a first trolley of the trolley assembly at a first end of the drilling mast. The first assembly includes a first frame, a plurality of first ground engaging members coupled to the first frame, and a first positioning system disposed on the first frame. The first positioning system includes a first housing and a first rotatable element that is rotatable relative to the first housing. The method also includes removably coupling the first end of the drilling mast with the first rotatable element of the first positioning system. The method further includes disposing a second assembly of the first trolley at a second end of the drilling mast. The second end of the drilling mast being spaced apart from the first end of the drilling mast. The second assembly including a second frame, a plurality of second ground engaging members coupled to the second frame, and a second positioning system disposed on the second frame. The second positioning system includes a second housing and a second rotatable element that is rotatable relative to the second housing. The method includes removably coupling the second end of the drilling mast with the second rotatable element of the second positioning system. The method also includes operating an actuation device of the first trolley. The actuation device is associated with at least one of the first assembly and the second assembly. The method further includes rotating the drilling mast relative to each of the first housing of the first positioning system and the second housing of the second positioning system based on the operation of the actuation device. The method includes disposing the drilling mast at a plurality of work positions based on the rotation of the drilling mast. The method also includes transporting, via the trolley assembly, the drilling mast between different work locations along a mast assembly line.

Other features and aspects of this disclosure will be apparent from the following description and the accompanying drawings.

### BRIEF DESCRIPTION OF THE DRAWINGS

FIGS. 1 and 2 are schematic perspective views of a trolley assembly for a drilling mast including a first trolley, according to an example of the present disclosure;

FIG. 3 is a schematic view of a layout of a mast assembly line for the drilling mast of FIG. 1, according to an example of the present disclosure;

FIG. 4 is a schematic view of a layout of the mast assembly line for the drilling mast of FIG. 1, according to another example of the present disclosure; and

FIG. 5 is a flowchart for a method of using the trolley assembly for the drilling mast, according to an example of the present disclosure.

### DETAILED DESCRIPTION

Wherever possible, the same reference numbers will be used throughout the drawings to refer to the same or like parts.

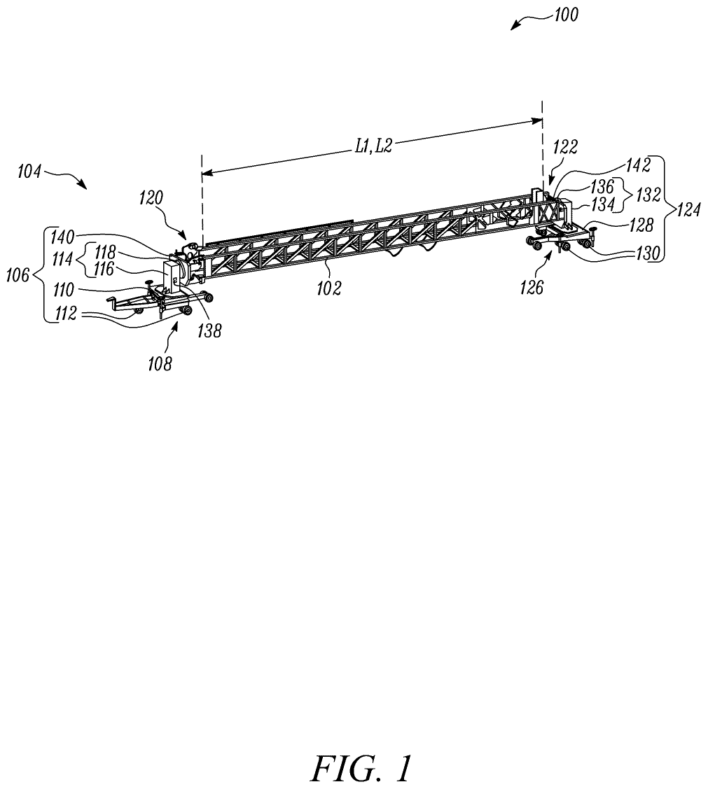

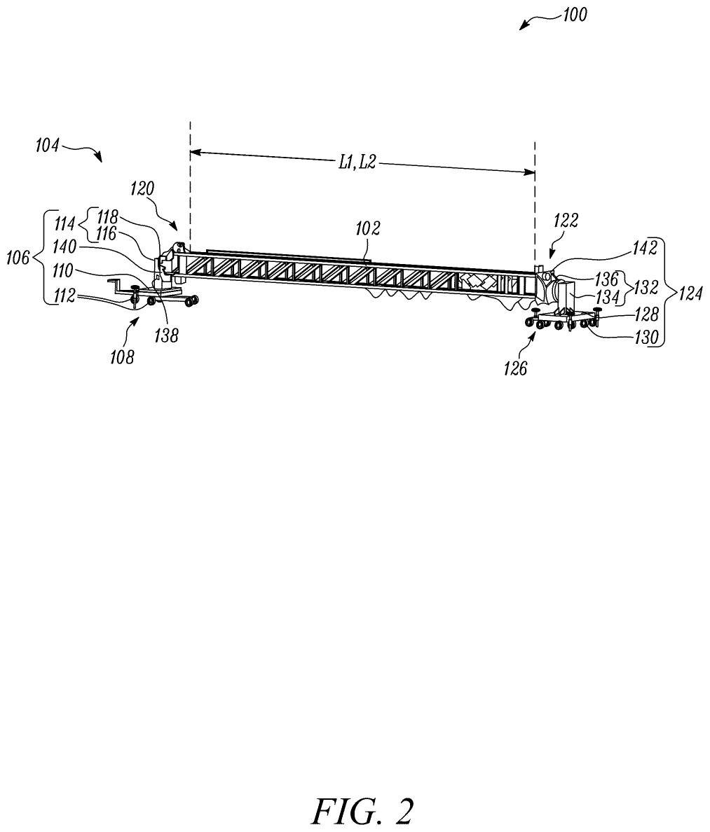

Referring to FIGS. 1 and 2, schematic perspective views of a trolley assembly 100 for a drilling mast 102 is illustrated. The drilling mast 102 may be associated with a drilling rig. In an example, the drilling mast 102 may be used over a wellbore to support a drilling equipment and may allow the drilling equipment to be lifted into and out of the wellbore. The drilling mast 102 may further be used in other applications such as bridge erection, road construction, housing construction, and the like. The drilling mast 102 defines a length L1 that may vary based on application attributes. In some examples, the length L1 of the drilling mast 102 may be in a range of 30 feet to 150 feet.

The trolley assembly 100 includes a first trolley 104. The first trolley 104 includes a first assembly 106 disposed at a first side 108 of the first trolley 104. The first assembly 106 includes a first frame 110. The first frame 110 may include suitable means to hitch the first trolley 104 with a vehicle/equipment that may transport the first trolley 104 between different locations. For example, the first frame 110 may be coupled with a forklift. The forklift may be used to transport the first trolley 104 between different locations.

The first assembly 106 also includes a number of first ground engaging members 112 coupled to the first frame 110. The first ground engaging members 112 include wheels that allow the first assembly 106 to maneuver on a ground surface to desired locations. In the illustrated example of FIGS. 1 and 2, the first assembly 106 includes four pairs of first ground engaging members 112. The first assembly 106 may include any number of first ground engaging members 112 based on application attributes.

The first assembly 106 further includes a first positioning system 114 disposed on the first frame 110. The first positioning system 114 includes a first housing 116 and a first rotatable element 118 that is rotatable relative to the first housing 116. The first housing 116 is substantially rectangular in shape. Further, the first rotatable element 118 is circular in shape. The first rotatable element 118 is removably coupled with a first end 120 of the drilling mast 102. Specifically, the first assembly 106 includes a first coupler 140 that removably couples the first rotatable element 118 with the drilling mast 102 to rotate the drilling mast 102 with the first rotatable element 118. The first coupler 140 may be designed to accommodate various configurations of the drilling mast 102. In some examples, the first positioning system 114 may further include a lifting system (not shown) fixedly coupled to the first housing 116. The lifting system may allow lifting of the drilling mast 102 to a certain height so that the drilling mast 102 may have a clearance from the ground surface. Thus, the drilling mast 102 may be lifted and disposed at a desire height to access surfaces/areas disposed at a lower side of the drilling mast 102.

The first trolley 104 also includes a second assembly 124 disposed at a second side 126 of the first trolley 104. The second assembly 124 is separate from the first assembly 106. The second assembly 124 is removably coupled with the first assembly 106 via the drilling mast 102. A length L2 between the first assembly 106 and the second assembly 124 is variable based on the length L1 of the drilling mast 102.

The second assembly 124 includes a second frame 128. The second assembly 124 also includes a number of second ground engaging members 130 coupled to the second frame 128. The second ground engaging members 130 include wheels that allow the second assembly 124 to maneuver on the ground surface to desired locations. In the illustrated example of FIGS. 1 and 2, the second ground engaging members 130 includes five pairs of second ground engaging members 130. The second assembly 124 may include any number of second ground engaging members 130 based on application attributes.

The second assembly 124 further includes a second positioning system 132 disposed on the second frame 128. The second positioning system 132 includes a second housing 134 and a second rotatable element 136 that is rotatable relative to the second housing 134. The second housing 134 is substantially rectangular in shape. Further, the second rotatable element 136 is circular in shape.

The second rotatable element 136 is removably coupled with a second end 122 of the drilling mast 102. The second end 122 of the drilling mast 102 is spaced apart from the first end 120 of the drilling mast 102. The second assembly 124 further includes a second coupler 142 that removably couples the second rotatable element 136 with the drilling mast 102 to rotate the drilling mast 102 with the second rotatable element 136. Thus, each of the first rotatable element 118 and the second rotatable element 136 is removably coupled with the drilling mast 102. The second coupler 142 may be designed to accommodate various configurations of the drilling mast 102.

The first trolley 104 further includes an actuation device 138 disposed in the first positioning system 114 and/or the second positioning system 132. In the illustrated example of FIGS. 1 and 2, the actuation device 138 is disposed in the first housing 116 of the first positioning system 114. Alternatively, the actuation device 138 may be disposed in the second housing 134 of the second positioning system 132. The actuation device 138 is operatively coupled with the first rotatable element 118. The actuation device 138 is a motor. In some examples, the motor is a hydraulic motor. In other examples, the motor may be a pneumatic motor. The actuation device 138 may include any other device that causes rotation of the drilling mast 102. In some examples, the first trolley 104 may also include a synchronous motor (not shown) that may be disposed in the second housing 134 of the second assembly 124. Upon operation of the actuation device 138, the actuation device 138 rotates the drilling mast 102 relative to each of the first housing 116 of the first positioning system 114 and the second housing 134 of the second positioning system 132 to dispose the drilling mast 102 at a number of work positions. Specifically, upon operation of the actuation device 138, the actuation device 138 rotates the drilling mast 102, via the first rotatable element 118. Further, upon operation of the actuation device 138, the first rotatable element 118, the drilling mast 102, and the second rotatable element 136 rotate in unison relative to each of the first housing 116 and the second housing 134 to dispose the drilling mast 102 at the number of work positions.

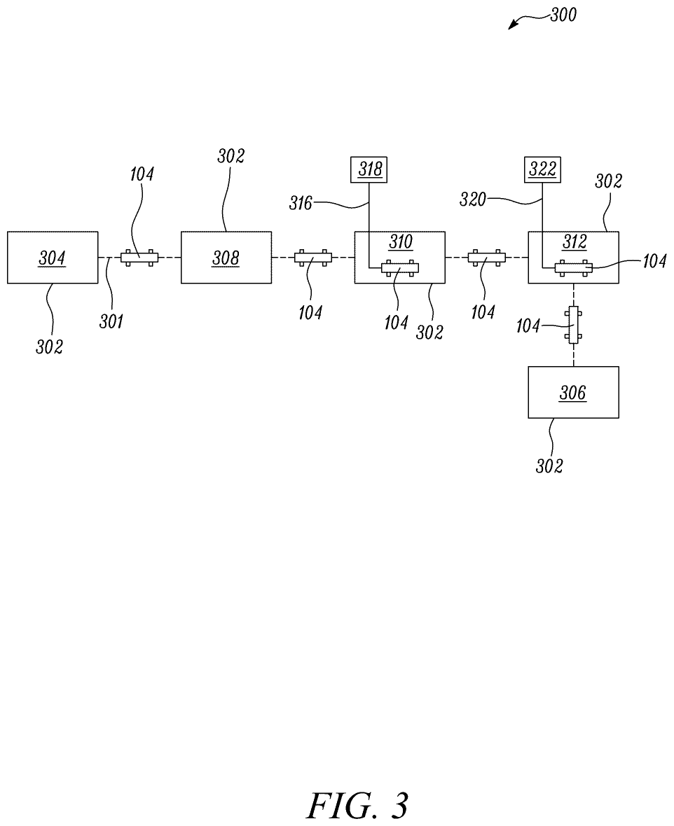

Referring to FIG. 3, a schematic view of a layout 300 of a mast assembly line 301 is illustrated, according to an example of the present disclosure. The mast assembly line 301 includes a number of work locations 302. Specifically, the number of work locations 302 includes one or more fabrication bays 304, one or more assembly bays 306, an inventory bay 308, a shot blast station 310, and a paint bay 312. In the illustrated embodiment of FIG. 3, a single fabrication bay 304 and a single assembly bay 306 is shown for illustrative purposes. Alternatively, any number of fabrication bays 304 and assembly bays 306 may be provided along the mast assembly line 301.

As used herein the term “fabrication bays” is defined as workstations at which one or more structural components of the drilling mast 102 (see FIGS. 1 and 2) may be fabricated, assembled, or joined together to form a complete structure of the drilling mast 102.

As used herein the term “assembly bays” is defined as workstations at which the drilling mast 102 may be assembled with one or more other components.

As used herein the term “inventory bay” is defined as a workstation at which the drilling mast 102 may be stored. Thus, the inventory bay may be a storage area for drilling masts.

As used herein the term “shot blast station” is defined as a workstation at which surfaces of the drilling mast 102 may be cleaned to eliminate dirt, rust, greases, oils etc, thus preparing the surfaces of the drilling mast 102 for painting, weld inspection, or the like.

As used herein the term “paint bay” is defined as a workstation at which surfaces of the drilling mast 102 may be painted.

It should be noted that the number of work locations 302 are not limited to the workstations defined above, and the mast assembly line 301 may include any number of workstations based on application attributes.

With reference to FIGS. 1 to 3, the first trolley 104 transports the drilling mast 102 between different work locations 302 along the mast assembly line 301. Specifically, the first trolley 104 transports the drilling mast 102 between each of the fabrication bay 304, the assembly bay 306, the inventory bay 308, the shot blast station 310, and the paint bay 312 along the mast assembly line 301. It should be noted that one or more first trolleys 104 may be used in the layout 300 to transport the drilling mast 102 between different work locations 302 for smooth and continuous assembly/manufacturing operations along the mast assembly line 301. Alternatively, a single first trolley 104 may be used to transport the drilling mast 102 between different work locations 302.

In an example, the first trolley 104 transports the drilling mast 102 from the fabrication bay 304 to the shot blast station 310 via the inventory bay 308. At the shot blast station 310, the actuation device 138 of the first trolley 104 receives a hydraulic power supply 316 from a hydraulic power system 318. The hydraulic power system 318 may be disposed proximal to the shot blast station 310. Upon operation of the actuation device 138, the first rotatable element 118, the drilling mast 102, and the second rotatable element 136 rotate in unison relative to each of the first housing 116 and the second housing 134 to dispose the drilling mast 102 at the number of work positions, in order to perform one or more operations at the shot blast station 310.

In an example, the first trolley 104 transports the drilling mast 102 from the shot blast station 310 to the paint bay 312. At the paint bay 312, the actuation device 138 of the first trolley receives a hydraulic power supply 320 from a hydraulic power system 322. The hydraulic power system 322 may be disposed proximal to the paint bay 312. Upon operation of the actuation device 138, the first rotatable element 118, the drilling mast 102, and the second rotatable element 136 rotate in unison relative to each of the first housing 116 and the second housing 134 to dispose the drilling mast 102 at the number of work positions, in order to perform one or more operations at the paint bay 312.

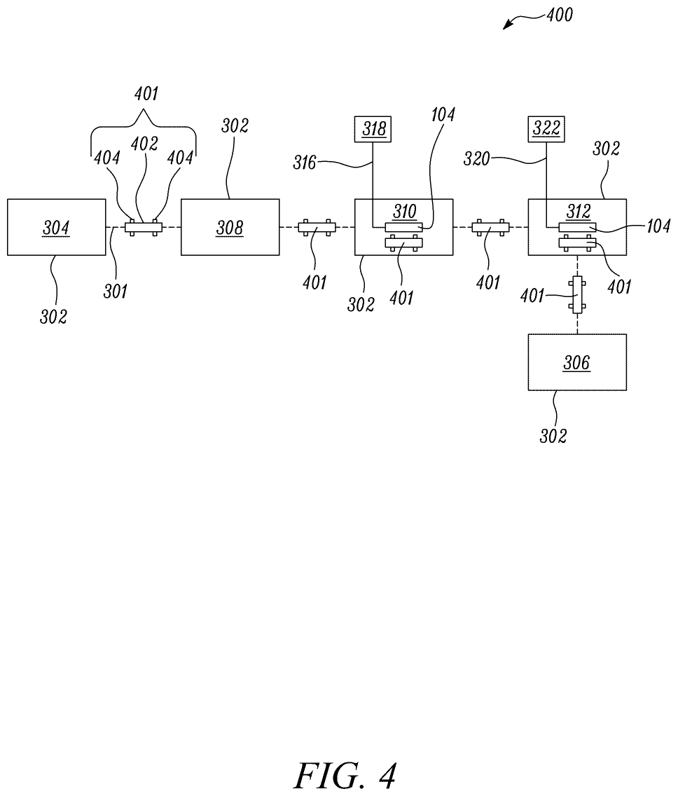

Referring to FIG. 4, a schematic view of a layout 400 of the mast assembly line 301 is illustrated, according to another example of the present disclosure. The layout 400 is substantially similar to the layout 300 of FIG. 3, with common elements being referred to by the same numerals.

The trolley assembly 100 further includes a second trolley 401. The second trolley 401 includes a mast holding frame 402 and a number of ground engaging members 404 coupled with the mast holding frame 402. The ground engaging members 404 include wheels that allow the second trolley 401 to maneuver on the ground surface to various locations. In the illustrated example of FIG. 4, the second trolley 401 includes four ground engaging members 404.

The second trolley 401 transports the drilling mast 102 (see FIG. 1) between different work locations 302 along the mast assembly line 301. The drilling mast 102 is positioned on the mast holding frame 402 to transport the drilling mast 102 between different work locations 302 along the mast assembly line 301. It should be noted that the layout 400 may use one or more second trolleys 401 to transport the drilling mast 102 between different work locations 302 along the mast assembly line 301.

In an example, the second trolley 401 transports the drilling mast 102 from the fabrication bay 304 to the inventory bay 308. Further, the second trolley 401 transports the drilling mast 102 from the inventory bay 308 to the shot blast station 310. At the shot blast station 310, the drilling mast 102 is unloaded from the second trolley 401 and is loaded on the first trolley 104, for example, via a saw horse, an overhead crane, and the like, for performing one or more operations on the drilling mast 102. Further, at the shot blast station 310, the actuation device 138 of the first trolley 104 receives the hydraulic power supply 316 from the hydraulic power system 318. Upon operation of the actuation device 138, the first rotatable element 118, the drilling mast 102, and the second rotatable element 136 rotate in unison relative to each of the first housing 116 and the second housing 134 to dispose the drilling mast 102 at the number of work positions, in order to perform one or more operations at the shot blast station 310.

After completion of the operations at the shot blast station 310, the drilling mast 102 is unloaded from the first trolley 104 and is loaded on the second trolley 401. The second trolley 401 then transports the drilling mast 102 from the shot blast station 310 to the paint bay 312. At the paint bay 312, the drilling mast 102 is unloaded from the second trolley 401 and is loaded on the first trolley 104. Further, at the paint bay 312, the actuation device 138 of the first trolley receives the hydraulic power supply 320 from the hydraulic power system 322. Upon operation of the actuation device 138, the first rotatable element 118, the drilling mast 102, and the second rotatable element 136 rotate in unison relative to each of the first housing 116 and the second housing 134 to dispose the drilling mast 102 at the number of work positions, in order to perform one or more operations at the paint bay 312.

After completion of the operations at the paint bay 312, the drilling mast 102 is transferred from the first trolley 104 to the second trolley 401. The second trolley 401 then transports the drilling mast 102 from the paint bay 312 to the assembly bay 306.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the trolley assembly 100 including the first trolley 104. The first trolley 104 transports the drilling mast 102 between different work locations 302 along the mast assembly line 301. The first trolley 104 includes the first assembly 106 including the number of first ground engaging members 112 and the second assembly 124 including the number of second ground engaging members 130. Each of the first ground engaging members 112 and the second ground engaging members 130 provide mobility to the first trolley 104, thereby allowing the first trolley 104 to transport the drilling mast 102 between different work locations 302.

As compared to conventional trolley assemblies, the trolley assembly 100 of the present disclosure may eliminate a need of loading and unloading of the drilling mast 102 multiple times to transport the drilling mast 102 between different work locations 302 that may otherwise require overhead cranes or forklifts. Thus, the trolley assembly 100 may transport the drilling mast 102 between different work locations 302 in areas where overhead cranes may not be available. Moreover, the first trolley 104 may transport the drilling mast 102 between different work locations 302 in lesser amount of time as compared to conventional trolley assemblies, as the first trolley 104 eliminates requirements of overhead cranes or other equipment to load/unload the drilling mast 102 at different work locations 302.

Further, the first assembly 106 of the first trolley 104 includes the first positioning system 114. The first positioning system 114 includes the first housing 116 and the first rotatable element 118. The second assembly 124 of the first trolley 104 includes the second positioning system 132. The second positioning system 132 includes the second housing 134 and the second rotatable element 136. The first trolley 104 further includes the actuation device 138 disposed in the first positioning system 114. Upon operation of the actuation device 138, the actuation device 138 rotates the drilling mast 102, via the first rotatable element 118, thereby allowing complete access of the drilling mast 102. Thus, the trolley assembly 100 may eliminate the need for operators to crawl under the drilling mast 102 to access a complete area of the drilling mast 102. The first trolley 104 may improve workplace ergonomics and may also reduce operator fatigue.

The first trolley 104 may reduce process cycle time for assembling/manufacturing the drilling mast 102 and may increase productivity of the mast assembly line 301. The first trolley 104 may be used in existing mast assembly lines. Overall, the first trolley 104 may reduce waiting time at different work locations 302, may allow quicker transportation of the drilling mast 102 between different work locations 302, and may reduce cost as well as complexity associated with the assembly of the drilling mast 102. In some examples, the first trolley 104 may be alone used to transport the drilling mast 102 between different work locations 302 and may also be deployed at different work locations 302 to perform the operations on the drilling mast 102. Alternatively, the first trolley 104 may be used at certain work locations 302, such as, the shot blast station 310 and the paint bay 312 to perform the operations on the drilling mast 102, and the second trolley 401 of the trolley assembly 100 may be used to transport the drilling mast 102 between different work locations 302 along the mast assembly line 301.

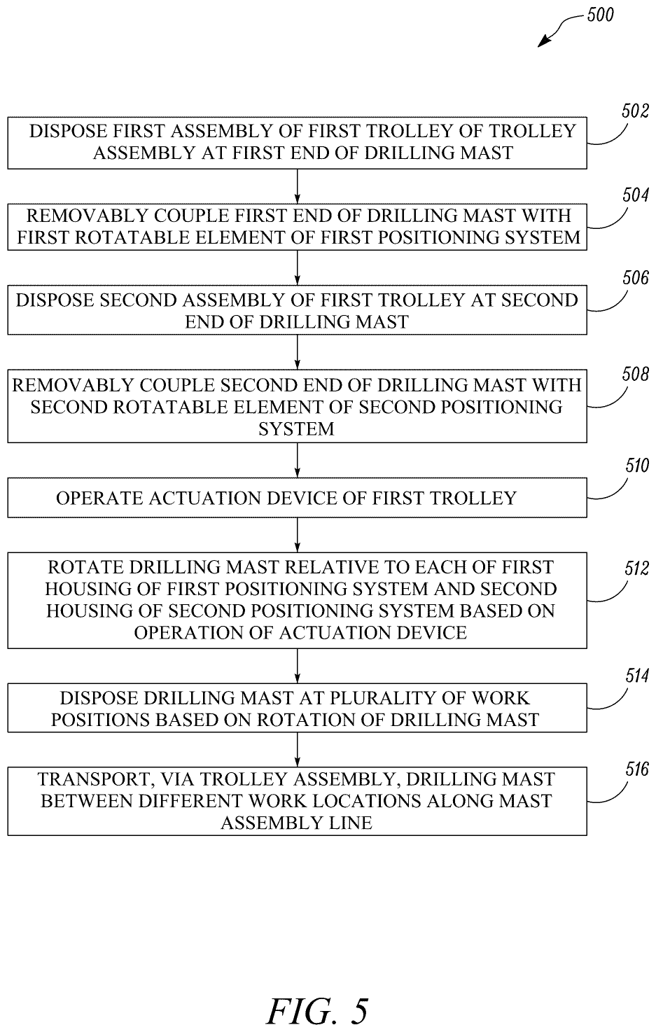

FIG. 5 is a flowchart of a method 500 of using the trolley assembly 100 for the drilling mast 102. With reference to FIGS. 1 to 3, at step 502, the first assembly 106 of the first trolley 104 of the trolley assembly 100 is disposed at the first end 120 of the drilling mast 102. The first assembly 106 includes the first frame 110, the number of first ground engaging members 112 coupled to the first frame 110, and the first positioning system 114 disposed on the first frame 110. The first positioning system 114 includes the first housing 116 and the first rotatable element 118 that is rotatable relative to the first housing 116.

At step 504, the first end 120 of the drilling mast 102 is removably coupled with the first rotatable element 118 of the first positioning system 114. The step 504 of removably coupling the first end 120 of the drilling mast 102 with the first rotatable element 118 of the first positioning system 114 further includes removably coupling, via the first coupler 140, the first rotatable element 118 with the drilling mast 102.

At step 506, the second assembly 124 of the first trolley 104 is disposed at the second end 122 of the drilling mast 102. The second end 122 of the drilling mast 102 is spaced apart from the first end 120 of the drilling mast 102. The second assembly 124 includes the second frame 128, the number of second ground engaging members 130 coupled to the second frame 128, and the second positioning system 132 disposed on the second frame 128. The second positioning system 132 includes the second housing 134 and the second rotatable element 136 that is rotatable relative to the second housing 134.

At step 508, the second end 122 of the drilling mast 102 is removably coupled with the second rotatable element 136 of the second positioning system 132. The step 508 of removably coupling the second end 122 of the drilling mast 102 with the second rotatable element 136 of the second positioning system 132 further includes removably coupling, via the second coupler 142, the second rotatable element 136 with the drilling mast 102. The length L2 between the first assembly 106 and the second assembly 124 is variable based on the length L1 of the drilling mast 102.

At step 510, the actuation device 138 of the first trolley 104 is operated. The actuation device 138 is associated with the first assembly 106 and/or the second assembly 124. The actuation device 138 is the hydraulic motor. The step 510 of operating the actuation device 138 further includes receiving, by the actuation device 138, the hydraulic power supply 316, 320 from the hydraulic power system 318, 322.

At step 512, the drilling mast 102 is rotated relative to each of the first housing 116 of the first positioning system 114 and the second housing 134 of the second positioning system 132 based on the operation of the actuation device 138. The actuation device 138 is disposed in the first housing 116 of the first positioning system 114. The actuation device 138 is operatively coupled with the first rotatable element 118. The step 512 of rotating the drilling mast 102 relative to each of the first housing 116 of the first positioning system 114 and the second housing 134 of the second positioning system 132 further includes rotating the first rotatable element 118 based on the operation of the actuation device 138, such that the first rotatable element 118 in turn rotates the drilling mast 102. Each of the first rotatable element 118 and the second rotatable element 136 is removably coupled with the drilling mast 102. The step 512 of rotating the drilling mast 102 relative to each of the first housing 116 of the first positioning system 114 and the second housing 134 of the second positioning system 132 further includes rotating each of the first rotatable element 118, the drilling mast 102, and the second rotatable element 136 in unison to dispose the drilling mast 102 at the number of work positions.

At step 514, the drilling mast 102 is disposed at the number of work positions based on the rotation of the drilling mast 102.

At step 516, the drilling mast 102 is transported via the trolley assembly 100 between different work locations 302 along the mast assembly line 301. The step 516 of transporting, via the trolley assembly 100, the drilling mast 102 between different work locations 302 along the mast assembly line 301 further includes a step at which the drilling mast 102 is transported via the first trolley 104 between different work locations 302 along the mast assembly line 301.

Referring to FIGS. 4 and 5, the trolley assembly 100 further includes the second trolley 401. The second trolley 401 includes the mast holding frame 402 and the number of ground engaging members 404 coupled with the mast holding frame 402. In some examples, the step 516 of transporting the drilling mast 102 via the trolley assembly 100, between different work locations 302 along the mast assembly line 301 further includes a step at which the drilling mast 102 is transferred from the first trolley 104 to the second trolley 401. The step 516 further includes a step at which the drilling mast 102 is positioned on the mast holding frame 402. The step 516 further includes a step at which the drilling mast 102 is transported, via the first trolley 104, between different work locations 302 along the mast assembly line 301.

The method 500 further includes a step at which the drilling mast 102 is transferred from the second trolley 401 to the first trolley 104 at the work location 302 to perform one or more operations on the drilling mast 102.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A trolley assembly for a drilling mast, the trolley assembly comprising:
a first trolley including:
a first assembly disposed at a first side of the first trolley, the first assembly including:
a first frame;
a plurality of first ground engaging members coupled to the first frame; and
a first positioning system disposed on the first frame, wherein the first positioning system includes a first housing and a first rotatable element that is rotatable relative to the first housing, and wherein the first rotatable element is adapted to be removably coupled with a first end of the drilling mast;
a second assembly disposed at a second side of the first trolley, wherein the second assembly is separate from the first assembly, and wherein the second assembly is adapted to be removably coupled with the first assembly via the drilling mast, the second assembly including:
a second frame;
a plurality of second ground engaging members coupled to the second frame; and
a second positioning system disposed on the second frame, wherein the second positioning system includes a second housing and a second rotatable element that is rotatable relative to the second housing, wherein the second rotatable element is adapted to be removably coupled with a second end of the drilling mast, the second end of the drilling mast being spaced apart from the first end of the drilling mast; and
an actuation device disposed in at least one of the first positioning system and the second positioning system, wherein, upon operation of the actuation device, the actuation device is adapted to rotate the drilling mast relative to each of the first housing of the first positioning system and the second housing of the second positioning system to dispose the drilling mast at a plurality of work positions.

2. The trolley assembly of claim 1, wherein the actuation device is disposed in the first housing of the first positioning system, and wherein the actuation device is operatively coupled with the first rotatable element, and wherein, upon operation of the actuation device, the actuation device is adapted to rotate the drilling mast, via the first rotatable element.

3. The trolley assembly of claim 1, wherein each of the first rotatable element and the second rotatable element is removably coupled with the drilling mast, and wherein, upon operation of the actuation device, the first rotatable element, the drilling mast, and the second rotatable element rotate in unison relative to each of the first housing and the second housing to dispose the drilling mast at the plurality of work positions.

4. The trolley assembly of claim 1, wherein the actuation device is a motor.

5. The trolley assembly of claim 4, wherein the motor is a hydraulic motor.

6. The trolley assembly of claim 1, wherein a length between the first assembly and the second assembly is variable based on a length of the drilling mast.

7. The trolley assembly of claim 1, wherein the first assembly further includes a first coupler adapted to removably couple the first rotatable element with the drilling mast to rotate the drilling mast with the first rotatable element.

8. The trolley assembly of claim 1, wherein the second assembly further includes a second coupler adapted to removably couple the second rotatable element with the drilling mast to rotate the drilling mast with the second rotatable element.

9. The trolley assembly of claim 1, wherein the first trolley is adapted to transport the drilling mast between different work locations along a mast assembly line.

10. The trolley assembly of claim 1 further comprising a second trolley, wherein the second trolley includes a mast holding frame and a plurality of ground engaging members coupled with the mast holding frame, wherein the second trolley is adapted to transport the drilling mast between different work locations along a mast assembly line, and wherein the drilling mast is adapted to be positioned on the mast holding frame to transport the drilling mast between different work locations along the mast assembly line.

11. A method of using a trolley assembly for a drilling mast, the method comprising:
disposing a first assembly of a first trolley of the trolley assembly at a first end of the drilling mast, the first assembly including a first frame, a plurality of first ground engaging members coupled to the first frame, and a first positioning system disposed on the first frame, wherein the first positioning system includes a first housing and a first rotatable element that is rotatable relative to the first housing;
removably coupling the first end of the drilling mast with the first rotatable element of the first positioning system;
disposing a second assembly of the first trolley at a second end of the drilling mast, the second end of the drilling mast being spaced apart from the first end of the drilling mast, the second assembly including a second frame, a plurality of second ground engaging members coupled to the second frame, and a second positioning system disposed on the second frame, wherein the second positioning system includes a second housing and a second rotatable element that is rotatable relative to the second housing;
removably coupling the second end of the drilling mast with the second rotatable element of the second positioning system;
operating an actuation device of the first trolley, wherein the actuation device is associated with at least one of the first assembly and the second assembly;
rotating the drilling mast relative to each of the first housing of the first positioning system and the second housing of the second positioning system based on the operation of the actuation device;
disposing the drilling mast at a plurality of work positions based on the rotation of the drilling mast; and
transporting, via the trolley assembly, the drilling mast between different work locations along a mast assembly line.

12. The method of claim 11, wherein the actuation device is disposed in the first housing of the first positioning system, wherein the actuation device is operatively coupled with the first rotatable element, and wherein the step of rotating the drilling mast relative to each of the first housing of the first positioning system and the second housing of the second positioning system further includes rotating the first rotatable element based on the operation of the actuation device, such that the first rotatable element in turn rotates the drilling mast.

13. The method of claim 11, wherein each of the first rotatable element and the second rotatable element is removably coupled with the drilling mast, and wherein the step of rotating the drilling mast relative to each of the first housing of the first positioning system and the second housing of the second positioning system further includes rotating each of the first rotatable element, the drilling mast, and the second rotatable element in unison to dispose the drilling mast at the plurality of work positions.

14. The method of claim 11, wherein the actuation device is a hydraulic motor, and wherein the step of operating the actuation device further includes receiving, by the actuation device, a hydraulic power supply from a hydraulic power system.

15. The method of claim 11, wherein a length between the first assembly and the second assembly is variable based on a length of the drilling mast.

16. The method of claim 11, wherein the step of removably coupling the first end of the drilling mast with the first rotatable element of the first positioning system further includes removably coupling, via a first coupler, the first rotatable element with the drilling mast.

17. The method of claim 11, wherein the step of removably coupling the second end of the drilling mast with the second rotatable element of the second positioning system further includes removably coupling, via a second coupler, the second rotatable element with the drilling mast.

18. The method of claim 11, wherein the step of transporting, via the trolley assembly, the drilling mast between different work locations along the mast assembly line further includes transporting, via the first trolley, the drilling mast between different work locations along the mast assembly line.

19. The method of claim 11, wherein the trolley assembly further includes a second trolley, wherein the second trolley includes a mast holding frame and a plurality of ground engaging members coupled with the mast holding frame, and wherein the step of transporting, via the trolley assembly, the drilling mast between different work locations along the mast assembly line further includes:
transferring the drilling mast from the first trolley to the second trolley;
positioning the drilling mast on the mast holding frame; and
transporting, via the first trolley, the drilling mast between different work locations along the mast assembly line.

20. The method of claim 19 further comprising transferring the drilling mast from the second trolley to the first trolley at a work location to perform one or more operations on the drilling mast.
